(19) United States
(12) Patent Application Publication
(10) Pub. No.: US 2015/0022052 A1
(43) Pub. Date: Jan. 22, 2015

(54) STATOR FOR ROTATING ELECTRIC MACHINE

(71) Applicant: DENSO CORPORATION, Kariya-city (JP)

(72) Inventors: Kazuhiro NOBATA, Chiryu-shi (JP); Toshiaki OOHARA, Okazaki-shi (JP); Youzou MATSUI, Toyota-shi (JP); Yoshiyasu KOZAKI, Haguri-gun (JP); Hiroyuki IKUTA, Anjo-shi (JP); Katsunori KUKI, Chiryu-shi (JP); Akio MORI, Chiryu-shi (JP); Takashi HOSHIYAMA, Tokai-shi (JP); Yoshihito TAKAHASHI, Obu-shi (JP)

(21) Appl. No.: 14/335,057

(22) Filed: Jul. 18, 2014

(30) Foreign Application Priority Data
Jul. 18, 2013 (JP) 2013-149442

(51) Int. Cl. H02K 1/18

(52) U.S. Cl. CPC H02K 1/185
USPC 310/216.135

(57) ABSTRACT

A stator includes a hollow cylindrical stator core, a stator coil and an outer cylinder. The stator core is comprised of a plurality of core segments that are arranged in a circumferential direction of the stator core to adjoin one another in the circumferential direction. The stator coil is mounted on the stator core. The outer cylinder is fitted on a radially outer periphery of the stator core. The outer cylinder has, at least, a protruding portion and a non-protruding portion. The protruding portion protrudes radially inward to include an abutting part that abuts the radially outer periphery of the stator core. The non-protruding portion extends, without protruding radially inward, to define a radial clearance between the radially outer periphery of the stator core and a radially inner surface of the non-protruding portion. The protruding and non-protruding portions are continuously formed in an axial direction of the outer cylinder.

### CROSS-REFERENCE TO RELATED APPLICATION

This application is based on and claims priority from Japanese Patent Application No. 2013-149442, filed on Jul. 18, 2013, the content of which is hereby incorporated by reference in its entirety into this application.

### BACKGROUND

1. Technical Field

The present invention relates to stators for rotating electric machines that are used in, for example, motor vehicles as electric motors and electric generators.

2. Description of Related Art

Conventionally, there are known stators for rotating electric machines which include a hollow cylindrical stator core, a stator coil and an outer cylinder. The stator core is comprised of a plurality of core segments that are arranged in the circumferential direction of the stator core to adjoin one another in the circumferential direction. The stator coil is mounted on the stator core. The outer cylinder is fitted on the radially outer surfaces of the core segments so as to fasten them together.

Moreover, Japanese Patent Application Publication No. JP2012161237A discloses a method of preventing relative rotation (or relative circumferential movement) between the outer cylinder and the stator core. Specifically, according to the method, the outer cylinder has a slit and a fastening portion for fastening the outer cylinder to the stator core. The slit extends in both the circumferential and axial directions of the outer cylinder and radially penetrates the outer cylinder to connect the radially outer and inner surfaces of the outer cylinder. The fastening portion is formed to be partially surrounded by the slit. In manufacturing the stator, after the outer cylinder is fitted onto the radially outer surface of the stator core (or the radially outer surfaces of the core segments), the fastening portion of the outer cylinder is plastically deformed radially inward into a recess formed in the radially outer surface of the stator core, thereby engaging with the recess. Consequently, with the engagement between the fastening portion of the outer cylinder and the recess of the stator core, the outer cylinder and the stator core are prevented from rotating (or circumferentially moving) relative to each other.

Japanese Patent No. JP4562093B2 discloses a method of fastening a stator core to a frame. Specifically, according to the method, the stator core has a plurality of recesses (or stator-side fastening portions) formed in the radially outer surface thereof. The frame has a plurality of protrusions (or frame-side fastening portions) formed on the radially inner surface thereof. Each of the protrusions of the frame is axially inserted in a corresponding one of the recesses of the stator core, thereby fastening the stator core to the frame. Consequently, with engagement between the corresponding pairs of the protrusions of the frame and the recesses of the stator core, relative rotation between the stator core and the frame is prevented.

Furthermore, in the conventional stators for rotating electric machines, to reduce electrical losses (e.g., iron loss), the stator core (or each of the core segments) is generally formed by laminating a plurality of steel sheets in the axial direction of the stator core. However, when the outer cylinder, which is generally formed of metal in one piece, is fitted on and thus abuts the radially outer surface of the stator core (or the radially outer surfaces of the core segments), there is formed a conductive path between the laminated steel sheets, thereby increasing the electrical losses of the stator.

In particular, according to the methods disclosed in the above patent documents, the fastening portions of the outer cylinder or the frame are configured to abut the stator core over a wide axial range. Consequently, the electrical losses of the stator may be considerably increased.

### SUMMARY

According to exemplary embodiments, there is provided a stator for a rotating electric machine. The stator includes a hollow cylindrical stator core, a stator coil and an outer cylinder. The stator core is comprised of a plurality of core segments that are arranged in a circumferential direction of the stator core to adjoin one another in the circumferential direction. The stator coil is mounted on the stator core. The outer cylinder is fitted on a radially outer periphery of the stator core. The outer cylinder has, at least, a protruding portion and a non-protruding portion. The protruding portion protrudes radially inward to include an abutting part that abuts the radially outer periphery of the stator core. The non-protruding portion extends, without protruding radially inward, to define a radial clearance between the radially outer periphery of the stator core and a radially inner surface of the non-protruding portion. The protruding portion and the non-protruding portion are continuously formed in an axial direction of the outer cylinder.

With the above configuration of the outer cylinder, it is possible to minimize the axial range over which the abutting part of the protruding portion abuts the radially outer periphery of the stator core. Consequently, when the stator core is formed by laminating a plurality of steel sheets in the axial direction, it is possible to minimize the length of a conductive path that is formed between the laminated steel sheets via the abutting part of the protruding portion. As a result, it is possible to minimize the increase in electrical losses of the stator due to the conductive path.

It is preferable that the protruding portion further includes an oblique part that extends obliquely with respect to the axial direction of the outer cylinder so as to connect the abutting part of the protruding portion with the non-protruding portion.

The stator core may have a recess formed in the radially outer periphery thereof; the protruding portion of the outer cylinder may be fitted in the recess of the stator core so that the abutting part of the protruding portion abuts a bottom surface of the recess. Further, the recess of the stator core may also have a pair of circumferential wall surfaces that face each other in the circumferential direction of the stator core; the abutting part of the protruding portion of the outer cylinder may preferably abut both the circumferential wall surfaces as well as the bottom surface of the recess.

It is preferable that on opposite circumferential sides of the protruding portion of the outer cylinder, there are respectively formed a pair of slits each of which radially penetrates the outer cylinder so as to connect radially outer and inner surfaces of the outer cylinder. It is further preferable that at each of a plurality of spots in the outer cylinder, there are formed one protruding portion and one pair of slits as described above; the plurality of spots are aligned with each other in the axial direction of the outer cylinder. Further, in this case, each of the abutting parts of the protruding portions may preferably have an open end. Furthermore, all the open ends of the abutting parts may be preferably positioned closest to a same one of axial ends of the outer cylinder in the respective protruding portions.

It is also preferable that at each of three or more spots in the outer cylinder, there are formed one protruding portion and one non-protruding portion as described above; the three or more spots are spaced from one another in a circumferential direction of the outer cylinder. Further, the number of spots where the protruding and non-protruding portions are formed may be preferably set to be equal to the number of the core segments of the stator core. For each of the core segments of the stator core, there may be preferably arranged a corresponding one of the protruding portions of the outer cylinder so that the abutting part of the corresponding protruding portion abuts a radially outer periphery of the core segment. Furthermore, the core segments of the stator core may include specific core segments each having a recess formed in its radially outer surface and normal core segments each having no recess formed in its radially outer surface. In this case, for each of the specific core segments, the corresponding protruding portion of the outer cylinder may be preferably fitted in the recess of the specific core segment so that the abutting part of the corresponding protruding portion abuts a bottom surface of the recess. On the other hand, for each of the normal core segments, the corresponding protruding portion of the outer cylinder may be preferably positioned so that the abutting part of the corresponding protruding portion abuts a circumferentially central area of the radially outer surface of the normal core segment.

It is also preferable that the outer cylinder further has, at each of opposite axial ends thereof, at least one restraining portion that abuts a corresponding one of opposite axial end faces of the stator core so as to restrain axial displacement of the stator core. It is further preferable that at either or both of the axial ends of the outer cylinder, the at least one restraining portion is formed by bending an axial end portion of the outer cylinder radially inward.

It is also preferable that the outer cylinder is formed so that the protruding portion has a smaller thickness than the non-protruding portion.

The stator may be mounted to a stator-mounting portion of a vehicle so that a radially outer surface of the non-protruding portion of the outer cylinder abuts an inner wall surface of the stator-mounting portion. Alternatively, the stator may be mounted to the stator-mounting portion of the vehicle so that a radially outer surface of the protruding portion of the outer cylinder abuts the inner wall surface of the stator-mounting portion.

### BRIEF DESCRIPTION OF THE DRAWINGS

The present invention will be understood more fully from the detailed description given hereinafter and from the accompanying drawings of exemplary embodiments, which, however, should not be taken to limit the invention to the specific embodiments but are for the purpose of explanation and understanding only.

In the accompanying drawings:

FIG. 1 is a schematic cross-sectional view of a rotating electric machine which includes a stator according to a first embodiment;

FIG. 2 is a perspective view of the assembly of a stator core and an outer cylinder of the stator according to the first embodiment;

FIG. 3 is a perspective view of the outer cylinder before being assembled to the stator core;

FIG. 4 is a cross-sectional view taken along the line IV-IV in FIG. 2;

FIG. 5 is a cross-sectional view taken along the line V-V in FIG. 4;

FIG. 6 is a cross-sectional view taken along the line VI-VI in FIG. 2;

FIG. 7 is a cross-sectional view taken along the line VII-VII in FIG. 6;

FIG. 8 is a perspective view of part of the assembly of a stator core and an outer cylinder of a stator according to a second embodiment;

FIG. 9 is a cross-sectional view taken along the line IX-IX in FIG. 8;

FIG. 10 is a perspective view of part of the assembly of a stator core and an outer cylinder of a stator according to a third embodiment;

FIG. 11 is a cross-sectional view taken along the line XI-XI in FIG. 10;

FIG. 12 is a perspective view of part of the assembly of a stator core and an outer cylinder of a stator according to a first modification;

FIG. 13 is a perspective view of part of the assembly of a stator core and an outer cylinder of a stator according to a second modification;

FIG. 14 is a perspective view of part of the assembly of a stator core and an outer cylinder of a stator according to a third modification;

FIG. 15 is a perspective view of part of the assembly of a stator core and an outer cylinder of a stator according to a fourth modification;

FIG. 16 is a perspective view of part of the assembly of a stator core and an outer cylinder of a stator according to a fifth modification;

FIG. 17 is a cross-sectional view of part of the assembly of the stator core and the outer cylinder of the stator according to the fifth modification;

FIG. 18 is a cross-sectional view of part of the assembly of a stator core and an outer cylinder of a stator according to a sixth modification;

FIG. 19 is a schematic view illustrating the configuration of an outer cylinder of a stator according to a seventh modification;

FIG. 20 is a cross-sectional view of part of the assembly of a stator core and the outer cylinder of the stator according to the seventh modification;

FIG. 21 is a perspective view of the assembly of a stator core and an outer cylinder of a stator according to an eighth modification;

FIG. 22 is a plan view of the assembly shown in FIG. 21;

FIG. 23 is a perspective view of the assembly of a stator core and an outer cylinder of a stator according to a ninth modification;

FIG. 24 is a cross-sectional view of part of the assembly of a stator core and an outer cylinder of a stator according to a tenth modification;

FIG. 25 is a perspective view of part of the outer cylinder of the stator according to the tenth modification;

FIG. 26 is a cross-sectional view of part of the assembly of a stator core and an outer cylinder of a stator according to an eleventh modification;

FIG. 27 is a schematic view illustrating a stator according to a twelfth modification which is mounted to a stator-mounting portion in a vehicle; and

FIG. 28 is a schematic view illustrating a stator according to a thirteenth modification which is mounted to a stator-mounting portion in a vehicle.

### DESCRIPTION OF EMBODIMENTS

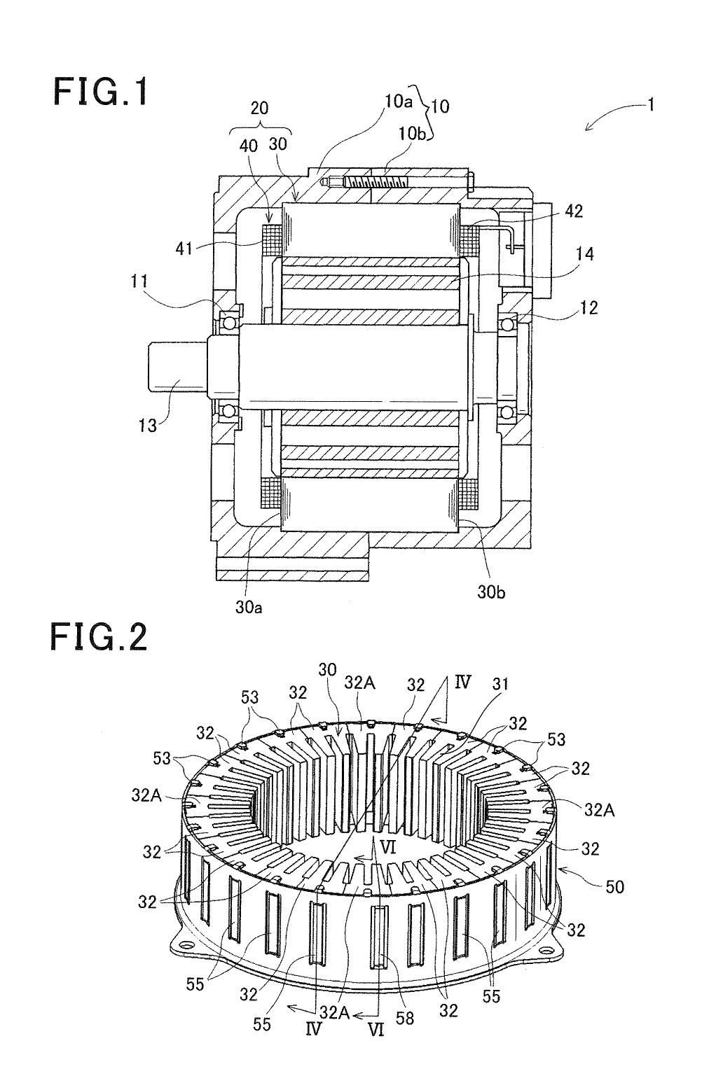

Exemplary embodiments and their modifications will be described hereinafter with reference to FIGS. 1-28. It should be noted that for the sake of clarity and ease of understanding, identical components having identical functions throughout the whole description have been marked, where possible, with the same reference numerals in each of the figures and that for the sake of avoiding redundancy, explanations of the identical components will not be repeated.

### First Embodiment

FIG. 1 shows the overall configuration of a rotating electric machine 1 which includes a stator 20 according to a first embodiment.

In the present embodiment, the rotating electric machine 1 is configured as an electric motor for use in a motor vehicle.

As shown in FIG. 1, the rotating electric machine 1 further includes a housing 10 and a rotor 14 in addition to the stator 20. The housing 10 is comprised of a pair of cup-shaped housing pieces 10a and 10b which are jointed together at the open ends thereof. The housing 10 has a pair of bearings 11 and 12 mounted therein, via which a rotating shaft 13 is rotatably supported by the housing 10. The rotor 14 is received in the housing 10 and fixed on the rotating shaft 13 so as to rotate together with the rotating shaft 13. The stator 20 is fixed in the housing 10 so as to surround the radially outer periphery of the rotor 14.

The rotor 14 includes a plurality of permanent magnets that form a plurality of magnetic poles on the radially outer periphery of the rotor 14 facing the radially inner periphery of the stator 20. The polarities of the magnetic poles alternate between north and south in the circumferential direction of the rotor 14. The number of the magnetic poles can be suitably set according to the design specification of the rotating electric machine 1. In the present embodiment, the number of the magnetic poles is set to be equal to, for example, eight (i.e., four north poles and four south poles).

Referring to FIGS. 1-7, the stator 20 includes a hollow cylindrical (or annular) stator core 30, a three-phase stator coil 40 mounted on the stator core 30, and an outer cylinder (or outer ring) 50 fitted on the radially outer surface of the stator core 30. In addition, the stator 20 may further have insulating paper interposed between the stator core 30 and the stator coil 40.

The stator core 30 has, as shown in FIG. 2, a plurality of slots 31 that are formed in the radially inner surface of the stator core 30 and spaced in the circumferential direction of the stator core 30 at equal intervals. For each of the slots 31, the depth direction of the slot 31 is coincident with a radial direction of the stator core 30. In the present embodiment, there are provided two slots 31 per magnetic pole of the rotor 14 that has the eight magnetic poles and per phase of the three-phase stator coil 40. Accordingly, the total number of the slots 31 formed in the stator core 30 is equal to 48 (i.e., 2×8×3).

Moreover, in the present embodiment, the stator core 30 is comprised of, for example, 24 core segments 32. The core segments 32 are arranged in the circumferential direction of the stator core 30 so as to adjoin one another in the circumferential direction.

As shown in FIGS. 2, 5 and 7, each of the core segments defines therein one of the slots 31. Moreover, each circumferentially-adjoining pair of the core segments 32 together defines a further one of the slots 31 therebetween. Each of the core segments 32 also has two tooth portions 33, which radially extend to form the one of the slots 31 therebetween, and a back core portion 34 that is formed radially outside the tooth portions 33 to connect them. In addition, all the back core portions 34 of the core segments 32 together make up a back core portion 34 of the stator core 30.

In the present embodiment, each of the core segments 32 is formed by laminating a plurality of magnetic steel sheets in the axial direction of the stator core 30. The magnetic steel sheets are formed by, for example, blanking and fixed together by, for example, staking.

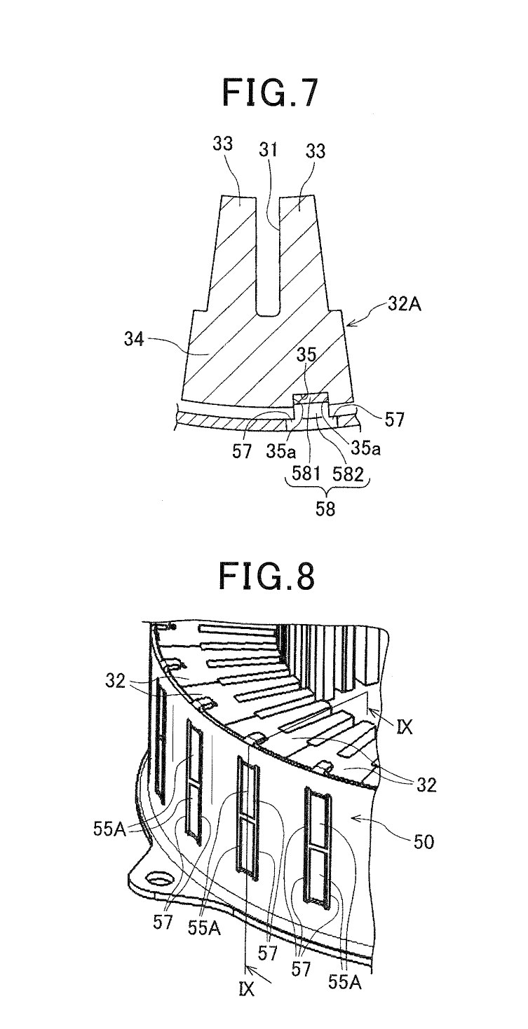

Moreover, in the present embodiment, of the 24 core segments 32 making up the stator core 30, every six core segments 32 include one specific core segment 32A that has a recess 35 formed in the radially outer surface thereof (see FIGS. 6-7). Accordingly, the stator core 30 includes a total of four specific stator segments 32A that are equally spaced in the circumferential direction of the stator core 30. In addition, for the sake of convenience of explanation, the remaining 20 core segments which have no recess 35 formed in the radially outer surface thereof will be referred to as normal core segments 32 hereinafter.

Further, in the present embodiment, as shown in FIGS. 6-7, for each of the specific core segments 32A, the recess 35 is formed in the radially outer surface of the specific core segment 32A so as to extend in the axial direction of the stator core 30 with a predetermined circumferential width. Moreover, the recess 35 is circumferentially positioned so as to radially align with one of the two tooth portions 33 formed in the specific core segment 32A (see FIG. 7). That is, the recess 35 is formed outside a circumferentially central part of the specific core segment 32A where a magnetic path is formed. Furthermore, the recess 35 is formed only in an axially central part of the radially outer surface of the specific core segment 32A (see FIG. 6). In addition, the recess 35 has a pair of circumferential wall surfaces 35a that extend both radially and axially and face each other in the circumferential direction of the stator core 30 (see FIG. 7).

The stator coil 40 is formed of a plurality (e.g., 12 in the present embodiment) of wave-shaped electric wires to have, as a whole, a hollow cylindrical shape. More specifically, the stator coil 40 is formed by first stacking the electric wires to form a flat band-shaped electric wire assembly and then spirally rolling the flat band-shaped electric wire assembly by, for example, six turns into the hollow cylindrical shape.

Moreover, after the assembly of the stator core 30 and the stator coil 40, each of the electric wires forming the stator coil 40 has a plurality of in-slot portions and a plurality of turn portions. Each of the in-slot portions is received in a corresponding one of the slots 31 of the stator core 30. Each of the turn portions is located outside the slots 31 of the stator core 30 to connect a corresponding pair of the in-slot portions of the electric wire which are respectively received in two different ones of the slots 31 of the stator core 30.

More specifically, in the present embodiment, the stator core 30 and the hollow cylindrical stator coil 40 are assembled by inserting the tooth portions 33 of the normal and specific core segments 32 and 32A respectively into the spaces formed between stacks of the in-slot portions of the electric wires from the radially outside of the stator coil 40; each of the stacks includes a predetermined number of the in-slot portions of the electric wires which are radially aligned with each other. Consequently, for each of the electric wires, the in-slot portions of the electric wire are received in corresponding slots 31 of the stator core 30 which are circumferentially spaced from one another at, for example, a six-slot pitch (i.e., 3 (the number of phases)×2 (the slot multiplier number)=6). Moreover, all the turn portions of the electric wires together make up a pair of annular coil ends 41 and 42 which respectively protrude from an opposite pair of axial end faces 30a and 30b of the stator core 30 as shown in FIG. 1.

In addition, though not shown in figures, in the present embodiment, each of the electric wires forming the stator coil 40 is configured with an electric conductor having a substantially rectangular cross section and an insulating coat that covers the outer surface of the electric conductor.

The outer cylinder 50 is axially fitted on the radially outer surfaces of the normal and specific core segments 32 and 32A, which are assembled to the stator coil 40 as described above, so as to fasten the core segments 32 and 32A together and thereby keep the hollow cylindrical shape of the stator core 30. In addition, all the radially outer surfaces of the normal and specific core segments 32 and 32A together make up the radially outer surface of the stator core 30.

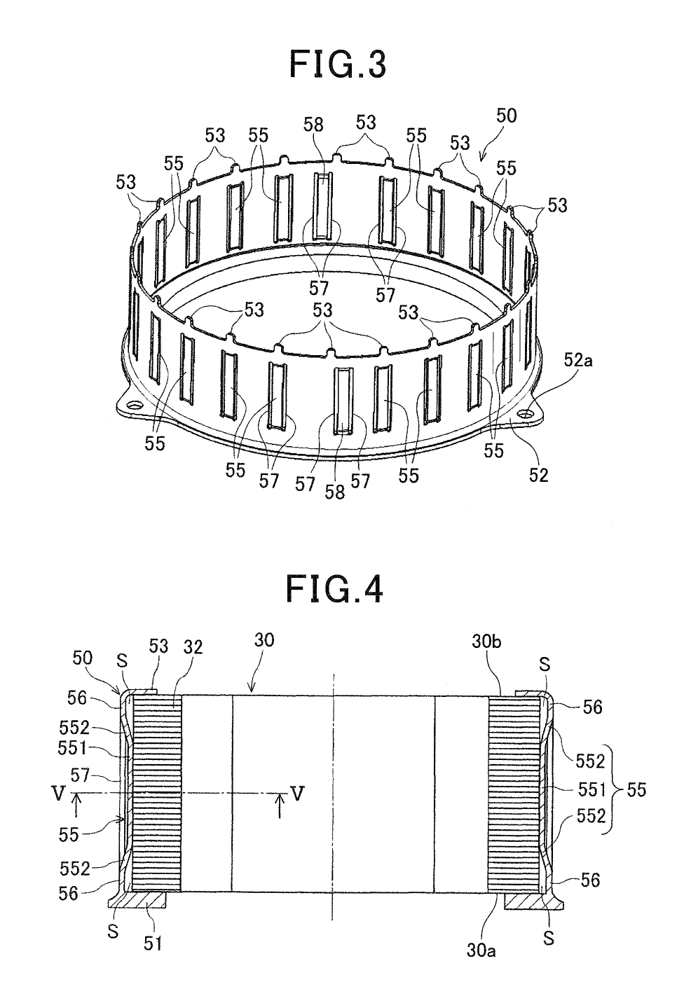

In the present embodiment, the outer cylinder 50 is made of, for example, a ferrous metal and has a hollow cylindrical (or annular) shape as shown in FIG. 3. The outer cylinder 50 has an inner diameter set to be greater than the outer diameter of the stator core 30 by a predetermined value.

At one axial end (i.e., the lower end in FIG. 3) of the outer cylinder 50, there is formed an annular first restraining portion 51 so as to protrude radially inward and thereby abut one axial end face 30a of the stator core 30 as shown in FIG. 4. Further, as shown in FIG. 3, at three different circumferential positions on the radially outer periphery of the first restraining portion 51, there are respectively formed three mounting portions 52 so as to protrude radially outward from the first restraining portion 51. In each of the mounting portions 52, there is formed a mounting hole 52a so as to penetrate the mounting portion 52 in its thickness direction (or in the axial direction of the outer cylinder 50).

At the other axial end (i.e., the upper end in FIG. 3) of the outer cylinder 50, there are formed a plurality (e.g., 24 in the present embodiment) of second restraining portions 53 so as to protrude radially inward and thereby abut the other axial end face 30b of the stator core 30 as shown in FIG. 4. The second restraining portions 53 are equally spaced in the circumferential direction of the outer cylinder 50 so that each of the second restraining portions 53 can be brought into abutment with a circumferentially central part of a corresponding one of the normal and specific core segments 32 and 32A.

More specifically, in the present embodiment, the second restraining portions 53 are formed so that before the outer cylinder 50 is fitted on the radially outer surface of the stator core 30, the second restraining portions 53 protrude axially outward from the other axial end of the outer cylinder 50 as shown in FIG. 3. Moreover, after the outer cylinder 50 is axially fitted from the other axial end thereof onto the radially outer surface of the stator core 30, each of the second restraining portions 53 is bent radially inward so as to abut the circumferentially central part of the corresponding one of the normal and specific core segments 32 and 32A as shown in FIG. 2.

Consequently, with the first and second restraining portions 51 and 53 of the outer cylinder 50, each of the normal and specific core segments 32 and 32A is prevented from being axially moved out of the outer cylinder 50.

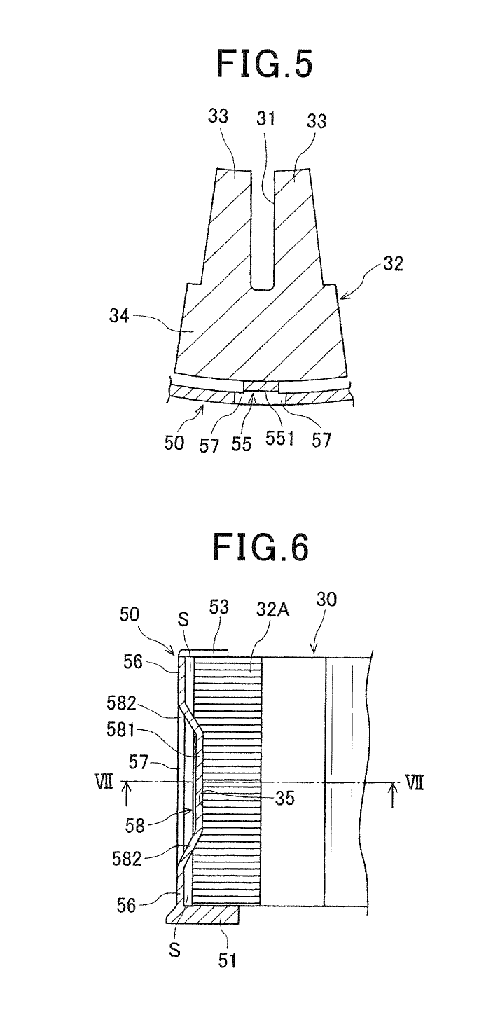

Moreover, in the present embodiment, as shown in FIGS. 3-5, for each of the 20 normal core segments 32, there are formed, at a spot in the outer cylinder 50 facing the radially outer surface of the normal core segment 32, a first protruding portion 55 and a pair of non-protruding portions 56 continuously in the axial direction of the outer cylinder 50. The first protruding portion 55 is formed so as to protrude radially inward from the main body of the outer cylinder 50. Moreover, the first protruding portion 55 is formed only in an axially central part of the outer cylinder 50 (see FIG. 4). Further, the first protruding portion 55 is circumferentially positioned so as to abut a circumferentially central area of the radially outer surface of the normal core segment 32 (see FIG. 5). In contrast, each of the non-protruding portions 56 is formed so as not to protrude radially inward from the main body of the outer cylinder 50. In other words, each of the non-protruding portions 56 is formed as a part of the main body of the outer cylinder 50. Moreover, each of the non-protruding portions 56 is formed so as to define a radial clearance S between the radially inner surface of the non-protruding portion 56 and the radially outer surface of the normal core segment 32 (see FIG. 4). Further, the non-protruding portions 56 are respectively formed on opposite axial sides of the first protruding portion 55 so as to continuously extend from the first protruding portion 56 (see FIG. 4). In other words, the non-protruding portions 56 are respectively formed at opposite axial ends of the outer cylinder 50 so as to have the first protruding portion 55 axially interposed therebetween. In addition, as shown in FIG. 3, on opposite circumferential sides of the first protruding portion 55, there are respectively formed a pair of slits 57 each of which radially penetrates the outer cylinder 50 to connect the radially outer and inner surfaces of the outer cylinder 50.

Furthermore, in the present embodiment, as shown in FIG. 4, the first protruding portion 55 is configured to include a first abutting part 551 and a pair of first oblique parts 552. The first abutting part 551 is positioned radially innermost in the first protruding portion 55 so as to abut the radially outer surface of the normal core segment 32. Moreover, the first abutting part 551 is axially centered in the first protruding portion 55 and extends in the axial direction of the outer cylinder 50. Each of the first oblique parts 552 extends obliquely with respect to the axial direction of the outer cylinder 50. Moreover, the first oblique parts 552 are respectively formed on opposite axial sides of the first abutting part 551. In other words, each of the first oblique parts 552 is formed, on one of the axial sides of the first abutting part 551, to connect the first abutting part 551 to that one of the non-protruding portions 56 which is located on the axial side.

On the other hand, as shown in FIGS. 3 and 6-7, for each of the four specific core segments 32A, there are formed, at a spot in the outer cylinder 50 facing the radially outer surface of the specific core segment 32A, a second protruding portion 58 and a pair of non-protruding portions 56 continuously in the axial direction of the outer cylinder 50. The second protruding portion 58 is formed so as to protrude radially inward from the main body of the outer cylinder 50. Moreover, the second protruding portion 58 is formed only in an axially central part of the outer cylinder 50 (see FIG. 6). Further, the second protruding portion 58 is circumferentially positioned so as to be fitted into the recess 35 formed in the radially outer surface of the specific core segment 32A (see FIG. 7). In contrast, each of the non-protruding portions 56 is formed so as not to protrude radially inward from the main body of the outer cylinder 50. In other words, each of the non-protruding portions 56 is formed as a part of the main body of the outer cylinder 50. Moreover, each of the non-protruding portions 56 is formed so as to define a radial clearance S between the radially inner surface of the non-protruding portion 56 and the radially outer surface of the specific core segment 32A (see FIG. 6). Further, the non-protruding portions 56 are respectively formed on opposite axial sides of the second protruding portion 58 so as to continuously extend from the second protruding portion 56 (see FIG. 6). In other words, the non-protruding portions 56 are respectively formed at opposite axial ends of the outer cylinder 50 so as to have the second protruding portion 58 axially interposed therebetween. In addition, as shown in FIG. 3, on opposite circumferential sides of the second protruding portion 58, there are respectively formed a pair of slits 57 each of which radially penetrates the outer cylinder 50 to connect the radially outer and inner surfaces of the outer cylinder 50.

Furthermore, in the present embodiment, as shown in FIG. 6, the second protruding portion 58 is configured to include a second abutting part 581 and a pair of second oblique parts 582. The second abutting part 581 is positioned radially innermost in the second protruding portion 58 so as to abut the bottom surface of the recess 35 of the specific core segment 32A. Moreover, the second abutting part 581 is axially centered in the second protruding portion 58 and extends in the axial direction of the outer cylinder 50. Each of the second oblique parts 582 extends obliquely with respect to the axial direction of the outer cylinder 50. Moreover, the second oblique parts 582 are respectively formed on opposite axial sides of the second abutting part 581. In other words, each of the second oblique parts 582 is formed, on one of the axial sides of the second abutting part 581, to connect the second abutting part 581 to that one of the non-protruding portions 56 which is located on the axial side.

Moreover, in the present embodiment, the second abutting part 581 has a circumferential width set to be slightly less than the circumferential width of the recess 35 of the specific core segment 32A. Further, the second abutting part 581 is fitted in the recess 35 of the specific core segment 32A so as to abut the circumferential wall surfaces 35a as well as the bottom surface of the recess 35. Consequently, with engagement between the second abutting part 581 and the circumferential wall surfaces 35a of the recess 35, relative rotation (or relative circumferential movement) between the outer cylinder 50 and the specific core segment 32A is prevented.

In addition, in the present embodiment, the second protruding portion 58 is configured to be identical to the above-described first protruding portion 55 except that: the second oblique parts 582 of the second protruding portion 58 have a larger oblique angle with respect to the axial direction of the outer cylinder 50 than the first oblique parts 552 of the first protruding portion 55; and the second abutting part 581 of the second protruding portion 58 protrudes radially inward from the main body of the outer cylinder 50 more than the first abutting part 551 of the first protruding portion 55.

In the present embodiment, the first and second protruding portions 55 and 58 are formed by performing press working on the outer cylinder 50 from the radially outside. Consequently, under the press pressure, the first and second protruding portions 55 and 58 are made to be thinner than the non-protruding portions 56, thereby becoming able to function as a spring based upon elastic deformation thereof. As a result, each of the normal and specific core segments 32 and 32A is urged radially inward by a corresponding one of the first and second abutting parts 551 and 581 of the first and second protruding portions 55 and 58, thereby keeping the stator core 30 in the hollow cylindrical shape. In addition, in the present embodiment, since there are formed the slits 57 on both circumferential sides of each of the first and second protruding portions 55 and 58, it is possible to easily perform the press working on the outer cylinder 50 at a low press pressure.

Moreover, with the configuration of the first and second protruding portions 55 and 58 according to the present embodiment, during the press working, the first and second oblique parts 552 and 582 tend to become thinner than the first and second abutting parts 551 and 581. Consequently, the first and second oblique parts 552 and 582 can be imparted with a stronger spring function than the first and second abutting parts 551 and 581.

The above-described stator 20 according to the present embodiment has the following advantages.

In the present embodiment, the stator 20 includes the hollow cylindrical stator core 30, the stator coil 40 and the outer cylinder 50. The stator core 30 is comprised of the normal and specific core segments 32 and 32A that are arranged in the circumferential direction of the stator core 30 to adjoin one another in the circumferential direction. The stator coil 40 is mounted on the stator core 30. The outer cylinder 50 is fitted on the radially outer periphery of the stator core 30. The outer cylinder 50 has, for each of the normal core segments 32 of the stator core 30, the first protruding portion 55 and the pair of non-protruding portions 56 corresponding to the normal core segment 32. The first protruding portion 55 protrudes radially inward to include the first abutting part 551 that abuts the radially outer periphery (more particularly, the radially outer surface) of the normal core segment 32. Each of the non-protruding portions 56 extends, without protruding radially inward, to define the radial clearance S between the radially outer periphery of the normal core segment 32 and the radially inner surface of the non-protruding portion 56. The first protruding portion 55 and the pair of non-protruding portions 56 are continuously formed and thus connected with one another in the axial direction of the outer cylinder 50. Moreover, the outer cylinder 50 also has, for each of the specific core segments 32A of the stator core 30, the second protruding portion 58 and the pair of non-protruding portions 56 corresponding to the specific core segment 32A. The second protruding portion 58 protrudes radially inward to include the second abutting part 581 that abuts the radially outer periphery (more particularly, the bottom surface of the recess 35) of the specific core segment 32A. Each of the non-protruding portions 56 extends, without protruding radially inward, to define the radial clearance S between the radially outer periphery (more particularly, the radially outer surface) of the specific core segment 32A and the radially inner surface of the non-protruding portion 56. The second protruding portion 58 and the pair of non-protruding portions 56 are continuously formed and thus connected with one another in the axial direction of the outer cylinder 50.

With the above configuration of the outer cylinder 50, it is possible to minimize the axial range over which the first and second abutting parts 551 and 581 of the first and second protruding portions 55 and 58 abut the radially outer peripheries of the normal and specific core segments 32 and 32A of the stator core 30. Consequently, it is possible to minimize the lengths of conductive paths that are formed between the laminated magnetic steel sheets of the normal and specific core segments 32 and 32A via the corresponding first and second abutting parts 551 and 581 of the first and second protruding portions 55 and 58. As a result, it is possible to minimize the increase in electrical losses of the stator 20 due to the conductive paths.

Moreover, in the present embodiment, each of the first protruding portions 55 of the outer cylinder 50 further includes the pair of first oblique parts 552 formed respectively on opposite axial sides of the first abutting part 551. Each of the first oblique parts 552 extends obliquely with respect to the axial direction of the outer cylinder 50 to connect the first abutting part 551 with one of the non-protruding portions 56. Similarly, each of the second protruding portions 58 of the outer cylinder 50 further includes the pair of second oblique parts 582 formed respectively on opposite axial sides of the second abutting part 581. Each of the second oblique parts 582 extends obliquely with respect to the axial direction of the outer cylinder 50 to connect the second abutting part 581 with one of the non-protruding portions 56.

With the first and second oblique parts 552 and 582 provided in the first and second protruding portions 55 and 58 of the outer cylinder 50, it is possible to reduce the load required for axially fitting the outer cylinder 50 onto the radially outer periphery of the stator core 30.

In the present embodiment, each of the specific core segments 32A of the stator core 30 has the recess 35 formed in the radially outer surface thereof. In the recess 35, there is fitted the corresponding second protruding portion 58 of the outer cylinder 50 so that the second abutting part 581 of the corresponding second protruding portion 58 abuts the circumferential side walls 35a as well as the bottom surface of the recess 35.

With the above configuration, it is possible to restrain radial displacement of each of the specific core segments 32A. Moreover, it is also possible to prevent relative rotation between the outer cylinder 50 and the stator core 30.

In the present embodiment, each of the first and second protruding portions 55 and 58 of the outer cylinder 50 has the pair of slits 57 respectively formed on opposite circumferential sides thereof. Each of the slits 57 radially penetrates the outer cylinder 50 so as to connect the radially outer and inner surfaces of the outer cylinder 50.

With the above configuration, it is possible to approach the stator core 30 from the radially outside of the outer cylinder 50 via the slits 57. Therefore, in bending the second restraining portions 53 radially inward after the fitting of the outer cylinder 50 onto the radially outer surface of the stator core 30, it is possible to fix the normal and specific core segments 32 and 32A using jigs inserted through the slits 57. Consequently, it is possible to easily and stably perform the process of bending the second restraining portions 53. In addition, it is also possible to measure the coaxiality between the stator core 30 and the outer cylinder 50 and the roundness of the stator core 30 using measuring instruments inserted through the slits 57.

In the present embodiment, the sets of the first protruding portion 55 and the non-protruding portions 56 and the sets of the second protruding portion 58 and the non-protruding portions 56 are respectively formed at 24 (i.e., more than three) spots in the outer cylinder 50; the 24 spots are spaced from one another in the circumferential direction of the outer cylinder 50.

With the above configuration, it is possible to easily make the axes of the stator core 30 and the outer cylinder 50 coincident with each other. Moreover, it is also possible to improve the coaxiality between the stator core 30 and the outer cylinder 50.

In the present embodiment, for each of the normal core segments 32 of the stator core 30, there is arranged the corresponding first protruding portion 55 of the outer cylinder 50 so that the first abutting part 551 of the corresponding first protruding portion 55 abuts the radially outer periphery (more particularly, the radially outer surface) of the normal core segment 32. Moreover, for each of the specific core segments 32A of the stator core 30, there is arranged the corresponding second protruding portion 58 of the outer cylinder 50 so that the second abutting part 581 of the corresponding second protruding portion 58 abuts the radially outer periphery (more particularly, the bottom surface of the recess 35) of the specific core segment 32A.

With the above arrangement, though the stator core 30 is comprised of the 24 normal and specific core segments 32 and 32A, it is still possible to reliably keep the stator core 30 in the hollow cylindrical shape.

In the present embodiment, at the one axial end of the outer cylinder 50, there is formed the annular first restraining portion 51 that abuts the one axial end face 30a of the stator core 30 to restrain axial displacement of the stator core 30 toward the one axial side. At the other axial end of the outer cylinder 50, there are formed the second restraining portions 53 that abut the other axial end face 30b of the stator core 30 to restrain axial displacement of the stator core 30 toward the other axial side.

Consequently, with the first and second restraining portions 51 and 53, it is possible to reliably restrain axial displacement of the stator core 30 in both opposite directions.

In addition, in the present embodiment, the normal and specific core segments 32 and 32A, each of which is formed by laminating the magnetic steel sheets in the axial direction of the stator core 30, are urged radially inward at the axially central parts thereof by the first and second abutting parts 551 and 581 of the corresponding first and second protruding portions 55 and 58. Consequently, the magnetic steel sheets might be axially spread (or separated from one another) at the radially inner ends of the normal and specific core segments 32 and 32A, thereby making contact with the coil ends 41 and 42 of the stator coil 40. However, in the present embodiment, with the first and second restraining portions 51 and 53 of the outer cylinder 50 restraining axial displacement of the normal and specific core segments 32 and 32A, it is possible to prevent the above problem from occurring in the stator 30.

In the present embodiment, each of the second restraining portions 53 is formed by bending an axial end portion of the outer cylinder 50 radially inward after the fitting of the outer cylinder 50 onto the radially outer surface of the stator core 30.

With the above method of forming the second restraining portions 53, it is possible to axially fit the outer cylinder 50 from the other axial end thereof onto the radially outer surface of the stator core 30 without causing interference between the stator core 30 and the outer cylinder 50.

In the present embodiment, the outer cylinder 50 is formed so that the first and second protruding portions 55 and 58 have a smaller thickness (or are thinner) than the non-protruding portions 56.

Consequently, the first and second protruding portions 55 and 58 can function as a spring to urge the normal and specific core segments 32 and 32A radially inward, thereby keeping the hollow cylindrical shape of the stator core 30.

### Second Embodiment

This embodiment illustrates a stator 20 which has almost the same structure as the stator 20 according to the first embodiment; accordingly, only the differences therebetween will be described hereinafter.

In the first embodiment, the outer cylinder 50 has, for each of the normal core segments 32 of the stator core 30, the first protruding portion 55 and the pair of non-protruding portions 56 corresponding to the normal core segment 32. The first protruding portion 55 and the non-protruding portions 56 are continuously formed in the axial direction of the outer cylinder 50 (see FIG. 4). Moreover, the outer cylinder 50 also has, for each of the specific core segments 32A of the stator core 30, the second protruding portion 58 and the pair of non-protruding portions 56 corresponding to the specific core segment 32A. The protruding portion 58 and the non-protruding portions 56 are continuously formed in the axial direction of the outer cylinder 50 (see FIG. 6).

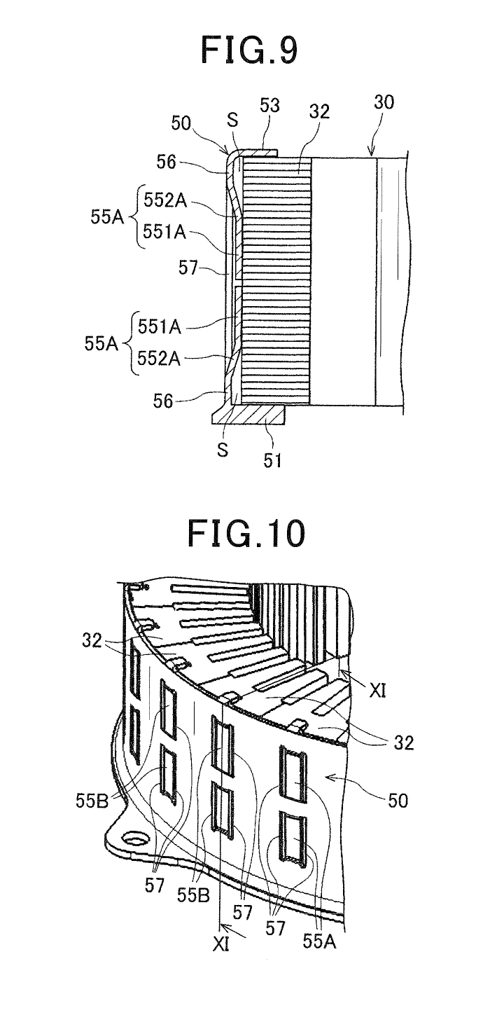

In comparison, in the present embodiment, the outer cylinder 50 has, for each of the normal core segments 32 of the stator core 30, two pairs of first protruding portions 55A and non-protruding portions 56 (see FIGS. 8-9) corresponding to the normal core segment 32; the two pairs of the first protruding portions 55A and the non-protruding portions 56 are respectively formed at two spots in the axial direction of the outer cylinder 50. Moreover, the outer cylinder 50 also has, for each of the specific core segments 32A of the stator core 30, two pairs of second protruding portions 58A and non-protruding portions 56 (not shown) corresponding to the specific core segment 32A; the two pairs of the second protruding portions 58A and the non-protruding portions 56 are respectively formed at two spots in the axial direction of the outer cylinder 50.

Specifically, as shown in FIGS. 8-9, for each of the normal core segments 32, one pair of the first protruding portion 55A and the non-protruding portion 56 corresponding to the normal core segment 32 is formed at one axial end (i.e., the lower end in FIGS. 8-9) of the outer cylinder 50; the first protruding portion 55A and the non-protruding portion 56 are continuously formed in the axial direction of the outer cylinder 50. The other pair of the first protruding portion 55A and the non-protruding portion 56 corresponding to the normal core segment 32 is formed at the other axial end (i.e., the upper end in FIGS. 8-9) of the outer cylinder 50; the first protruding portion 55A and the non-protruding portion 56 are continuously formed in the axial direction of the outer cylinder 50.

That is, the two pairs of the first protruding portions 55A and the non-protruding portions 56 in the present embodiment can be regarded as being obtained by dividing the single set of the first protruding portion 55 and the non-protruding portions 56 in the first embodiment into two parts by bisecting the first protruding portion 55 at the axial center thereof.

Accordingly, in the present embodiment, each of the first protruding portions 55A includes a first oblique part 552A connected with the non-protruding portion 56 and a first abutting part 551A that has one end connected with the first oblique part 552A and the other end open (or free).

With the above configuration, the radially-inward urging force of each of the first abutting parts 551A is reduced in comparison with that of each of the first abutting parts 551 in the first embodiment. Consequently, it is possible to more easily and smoothly fit the outer cylinder 50 onto the radially outer surface of the stator core 30 at a lower load. As a result, it is possible to facilitate the fitting process while preventing burrs or damage from occurring in the stator core 30 and the outer cylinder 50.

As to the second protruding portions 58A of the outer cylinder 50 corresponding to the specific core segments 32A of the stator core 30, they have almost the same configuration as the above-described first protruding portions 55A. Accordingly, for the sake of avoiding redundancy, explanation of the second protruding portions 58A is omitted hereinafter.

In addition, the stator 20 according to the present embodiment also has advantages similar to those described in the first embodiment.

### Third Embodiment

This embodiment illustrates a stator 20 which has almost the same structure as the stator 20 according to the second embodiment; accordingly, the differences therebetween will be mainly described hereinafter.

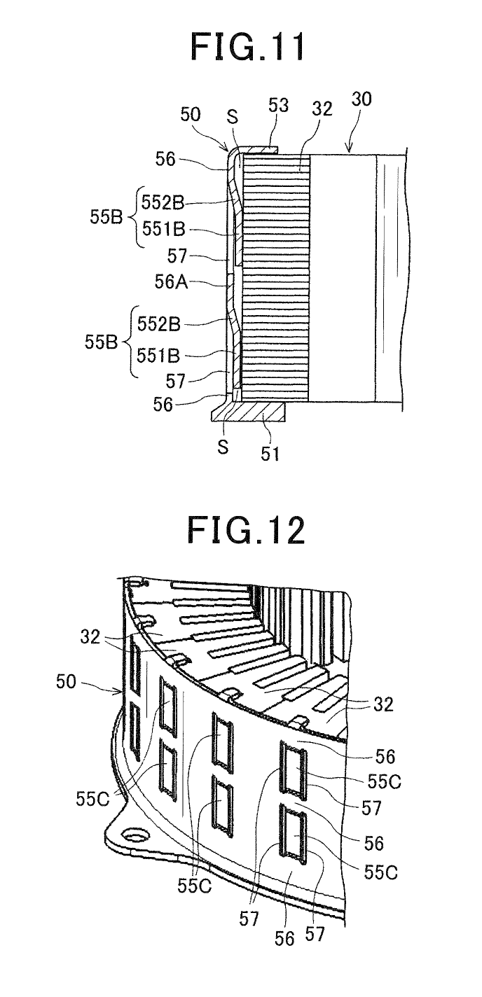

In the present embodiment, as shown in FIGS. 10-11, the outer cylinder 50 has, for each of the normal core segments 32 of the stator core 30, two pairs of first protruding portions 55B and non-protruding portions 56 corresponding to the normal core segment 32. One pair of the first protruding portion 55B and the non-protruding portion 56 is formed at one axial end (i.e., the lower end in FIGS. 10-11) of the outer cylinder 50. The other pair of the first protruding portion 55B and the non-protruding portion 56 is formed at the other axial end (i.e., the upper end in FIGS. 10-11) of the outer cylinder 50. Moreover, though not shown in the figures, the outer cylinder 50 also has, for each of the specific core segments 32A of the stator core 30, two pairs of second protruding portions 58B and non-protruding portions 56 corresponding to the specific core segment 32A. One pair of the second protruding portion 58B and the non-protruding portion 56 is formed at the one axial end of the outer cylinder 50. The other pair of the second protruding portion 58B and the non-protruding portion 56 is formed at the other axial end of the outer cylinder 50.

Moreover, in the present embodiment, as shown in FIGS. 10-11, the outer cylinder 50 further has, for each of the normal core segments 32 of the stator core 30, an intermediate non-protruding portion 56A formed between the two pairs of the first protruding portions 55B and the non-protruding portions 56 corresponding to the normal core segment 32. Further, the intermediate non-protruding portion 56A is formed continuously (or integrally) with the first protruding portion 55B located on the one axial side (i.e., the lower side in FIGS. 10-11), but separately from the first protruding portion 55B located on the other axial side (i.e., the upper side in FIGS. 10-11).

More specifically, the first protruding portion 55B located on the one axial side of the intermediate non-protruding portion 56A includes a first oblique part 552B connected with the intermediate non-protruding portion 56A and a first abutting part 551B that has one end connected with the first oblique part 552B and the other end open (or free). The first protruding portion 55B located on the other axial side of the intermediate non-protruding portion 56A includes a first oblique part 552B connected with the non-protruding portion 56 formed at the other axial end of the outer cylinder 50 and a first abutting part 551B that has one end connected with the first oblique part 552B and the other end open.

Accordingly, in the present embodiment, in each of the first protruding portions 55B, the open end of the first abutting part 551B is positioned closest to the one axial end of the outer cylinder 50. In other words, all the open ends of the first abutting parts 551B are positioned closest to the same axial end of the outer cylinder 50 in the respective first protruding portions 55B.

Consequently, compared to the second embodiment, it is possible to more easily and smoothly fit the outer cylinder 50 from the other axial end thereof (i.e., from the upper end in FIGS. 10-11) onto the stator core 30 at a lower load. As a result, it is possible to further facilitate the fitting process while more reliably preventing burrs or damage from occurring in the stator core 30 and the outer cylinder 50.

As to the second protruding portions 58B of the outer cylinder 50 corresponding to the specific core segments 32A of the stator core 30, they have almost the same configuration as the above-described first protruding portions 55B. Accordingly, for the sake of avoiding redundancy, explanation of the second protruding portions 58B is omitted hereinafter.

In addition, the stator 20 according to the present embodiment also has advantages similar to those described in the first embodiment.

While the above particular embodiments have been shown and described, it will be understood by those skilled in the art that various modifications, changes, and improvements may be made without departing from the spirit of the invention.

For example, the following modifications may be made. In addition, it should be noted that for the sake of simplicity, the stator coil 40 is omitted from the figures illustrating the flowing modifications.

### [First Modification]

In the first embodiment, the outer cylinder 50 has, for each of the normal core segments 32 of the stator core 30, only one set of the first protruding portion 55 and the slits 57 corresponding to the normal core segment 32. Moreover, the outer cylinder 50 has, for each of the specific core segments 32A of the stator core 30, only one set of the second protruding portion 58 and the slits 57 corresponding to the specific core segment 32A (see FIGS. 2-3).

In comparison, in this modification, as shown in FIG. 12, the outer cylinder 50 has, for each of the normal core segments 32 of the stator core 30, a plurality (e.g., two) of sets of first protruding portions 55C and slits 57 corresponding to the normal core segment 32. Each set consists of one first protruding portion 55C and one pair of slits 57 respectively formed on opposite circumferential sides of the first protruding portion 55C. The plurality of sets of the first protruding portions 55C and the slits 57 are respectively formed at a plurality of spots which are aligned with each other in the axial direction of the outer cylinder 50. Moreover, though not shown in the figures, the outer cylinder 50 has, for each of the specific core segments 32A of the stator core 30, a plurality (e.g., two) of sets of second protruding portions 58C and slits 57 corresponding to the specific core segment 32A. Each set consists of one second protruding portion 58C and one pair of slits 57 respectively formed on opposite circumferential sides of the second protruding portion 58C. The plurality of sets of the second protruding portions 58C and the slits 57 are respectively formed at a plurality of spots which are aligned with each other in the axial direction of the outer cylinder 50.

With the above configuration, the axial lengths of the first and second protruding portions 55C and 58C are reduced in comparison with those of the first and second protruding portions 55 and 58 in the first embodiment. Consequently, in forming the first and second protruding portions 55C and 58C by press working, it is possible to reduce the required press load.

Moreover, as shown in FIG. 12, between every two adjacent sets of the first protruding portions 55C and the slits 57, there is formed an additional non-protruding portion 56. Similarly, though not shown in the figures, between every two adjacent sets of the second protruding portions 58C and the slits 57, there is formed an additional non-protruding portion 56. Consequently, with the additional non-protruding portions 56, the rigidity of the outer cylinder 50 is improved.

### [Second Modification]

This modification is a combination of the first embodiment and the first modification.

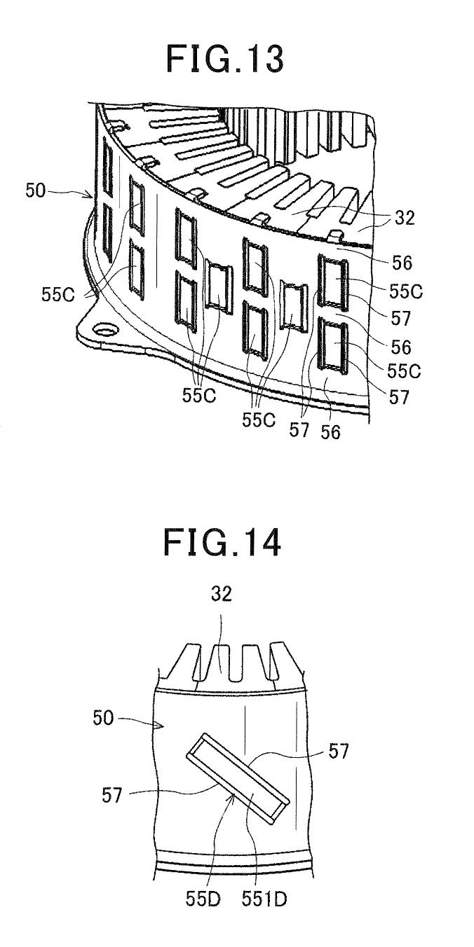

Specifically, in this modification, as shown in FIG. 13, some of the normal core segments 32 of the stator core 30 each have only one corresponding set of the first protruding portion 55 and the slits 57 formed in the outer cylinder 50 as in the first embodiment. On the other hand, the remaining normal core segments 32 each have a plurality (e.g., two) of corresponding sets of the first protruding portions 55C and the slits 57 formed in the outer cylinder 50 as in the first modification.

Moreover, though not shown in the figures, some of the specific core segments 32A of the stator core 30 each have only one corresponding set of the second protruding portion 58 and the slits 57 formed in the outer cylinder 50 as in the first embodiment. On the other hand, the remaining specific core segments 32A each have a plurality (e.g., two) of corresponding sets of the second protruding portions 58C and the slits 57 formed in the outer cylinder 50 as in the first modification.

### [Third Modification]

In the first embodiment, each of the first protruding portions 55 of the outer cylinder 50 and the pair of slits 57 respectively on the opposite circumferential sides of the first protruding portion 55 are formed so as to extend in the axial direction of the outer cylinder 50. Moreover, each of the second protruding portions 58 of the outer cylinder 50 and the pair of slits 57 respectively on the opposite circumferential sides of the second protruding portion 58 are also formed so as to extend in the axial direction of the outer cylinder 50 (see FIGS. 2-3).

In comparison, in this modification, as shown in FIG. 14, each of the first protruding portions 55D of the outer cylinder 50 and the pair of slits 57 respectively on the opposite circumferential sides of the first protruding portion 55D are formed so as to extend obliquely at an angle of about 45° with respect to the axial direction of the outer cylinder 50. Moreover, though not shown in the figures, each of the second protruding portions 58D of the outer cylinder 50 and the pair of slits 57 respectively on the opposite circumferential sides of the second protruding portion 58D are also formed so as to extend obliquely at an angle of about 45° with respect to the axial direction of the outer cylinder 50. In addition, the recesses 35 of the specific core segments 32A are formed so as to allow the second abutting parts 581D of the second protruding portions 58D to be respectively fitted therein.

With the above configuration, the conductive paths, which are formed between the laminated magnetic steel sheets of the normal and specific core segments 32 and 32A via the corresponding first and second abutting parts 551D and 581D of the first and second protruding portions 55 and 58, also extend obliquely with respect to the axial direction of the outer cylinder 50. Consequently, current loops formed in the stator 20 can be reduced, thereby more reliably reducing electrical losses of the stator 20.

### [Forth Modification]

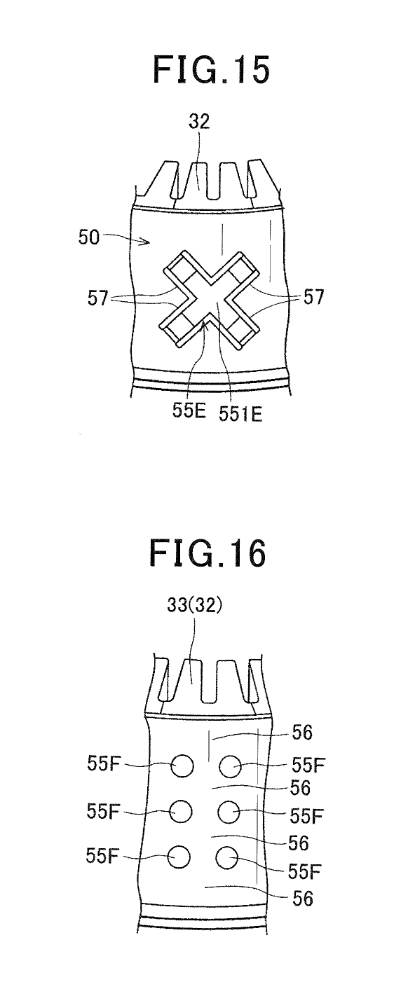

In this modification, as shown in FIG. 15, each of the first protruding portions 55E of the outer cylinder 50 is made up of two sections. The first section is inclined with respect to the axial direction of the outer cylinder 50 at an angle of about 45° toward one circumferential side. The second section is inclined with respect to the axial direction of the outer cylinder 50 at an angle of about 45° toward the other circumferential side. That is, the two sections extend perpendicular to each other. Further, the two are integrated at the centers thereof to form a cross-shaped first abutting part 551E of the first protruding portion 55E. The first abutting part 551E abuts the radially outer surface of the corresponding normal core segment 32 of the stator core 30.

Moreover, though not shown in the figures, each of the second protruding portions 58E of the outer cylinder 50 is also made up of two sections. The first section is inclined with respect to the axial direction of the outer cylinder 50 at an angle of about 45° toward one circumferential side. The second section is inclined with respect to the axial direction of the outer cylinder 50 at an angle of about 45° toward the other circumferential side. Further, the two sections are integrated at the centers thereof to form a cross-shaped second abutting part 581E of the second protruding portion 58E. The second abutting part 581E abuts the bottom surface of the recess 35 of the corresponding specific core segment 32A of the stator core 30. In addition, the recess 35 is also cross-shaped so as to allow the second abutting part 581E to be fitted therein.

With the above configuration, it is possible to achieve the same advantageous effects as described in the third modification.

### [Fifth Modification]

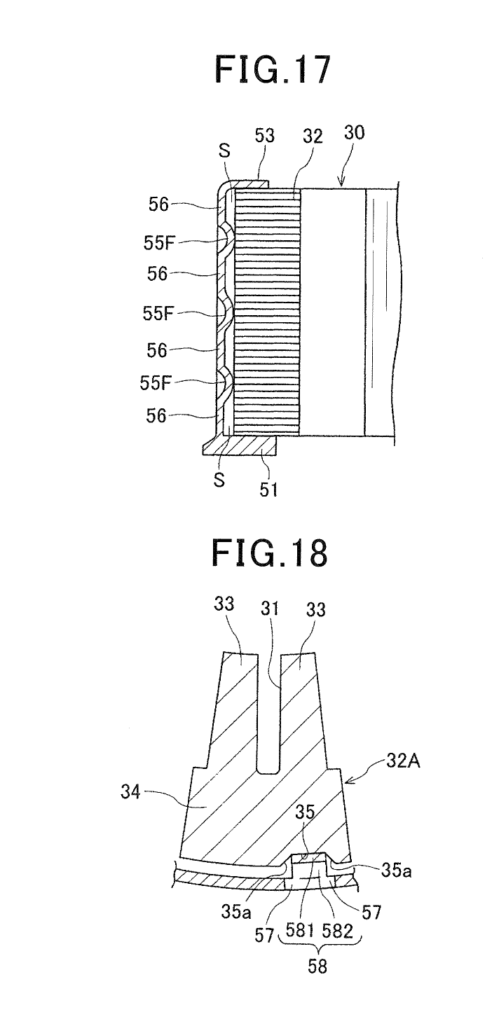

In this modification, as shown in FIGS. 16-17, the outer cylinder 50 has, for each of the normal core segments 32 of the stator core 30, a plurality (e.g., six) of first protruding portions 55F that protrude radially inward to abut the radially outer surface of the normal core segment 32. The first protruding portions 55F are circular in plan view (see FIG. 16) and hemispherical in cross-sectional view (FIG. 17). The first protruding portions 55F are formed continuously with a plurality of non-protruding portions 56 in the axial direction of the outer cylinder 50. More specifically, in this modification, three of the six first protruding portions 55F are formed alternately with four non-protruding portions 56 in the axial direction of the outer cylinder 50 and circumferentially positioned so as to radially align with one of the two tooth portions 33 of the normal core segment 32. On the other hand, the remaining three first protruding portions 55F are formed alternately with four non-protruding portions 56 in the axial direction of the outer cylinder 50 and circumferentially positioned so as to radially align with the other tooth portion 33 of the normal core segment 32.

Moreover, though not shown in the figures, the outer cylinder 50 also has, for each of the specific core segments 32A of the stator core 30, a plurality (e.g., six) of second protruding portions 58F that protrude radially inward so as to be respectively fitted in a plurality of recesses 35 formed in the radially outer surface of the specific core segment 32A. The second protruding portions 58F are shaped and arranged in the same manner as the above-described first protruding portions 55F; accordingly, detailed explanation of the second protruding portions 58F is omitted hereinafter. In addition, the recesses 35 of the specific core segment 32A are hemispherical-shaped so as to allow the second protruding portions 58F to be respectively fitted therein.

With the above configuration of the stator 20 according to the present modification, the axial range over which each of the first and second protruding portions 55F and 58F of the outer cylinder 50 abuts the radially outer periphery of the corresponding one of the normal and specific core segments 32 and 32A of the stator core 30 can be minimized. As a result, it is possible to more reliably reduce electrical losses of the stator 20.

In addition, in this modification, the first and second protruding portions 55F and 58F are formed by performing press working on the outer cylinder 50 from the radially outside. However, the first and second protruding portions 55F and 58F may be formed separately from and then joined to the main body of the outer cylinder 50.

### [Sixth Modification]

In the first embodiment, for each of the specific core segments 32A of the stator core 30, the recess 35 is formed in the radially outer surface of the specific core segment 32A so that the circumferential width (i.e., the distance between the circumferential wall surfaces 35a) of the recess 35 is kept constant from the bottom to the open end of the recess 35 (see FIG. 7).

In comparison, in this modification, as shown in FIG. 18, for each of the specific core segments 32A of the stator core 30, the recess 35 is formed in the radially outer surface of the specific core segment 32A so that the circumferential width of the recess 35 gradually increases from the bottom to the open end of the recess 35.

With the above configuration, in fitting the outer cylinder 50 onto the radially outer surface of the stator core 30, each of the second abutting parts 581 of the second protruding portions 58 of the outer cylinder 50 can be reliably guided by the circumferential wall surfaces 35a of the recess 35 of the corresponding specific core segment 32A to the bottom of the recess 35. Consequently, the stator core 30 and the outer cylinder 50 can be assembled into such a state that they are accurately positioned relative to each other.

### [Seventh Modification]

In the first embodiment, the first and second protruding portions 55 and 58 are formed by performing press working on the outer cylinder 50 from the radially outside. That is, the outer cylinder 50 has a one-piece construction.

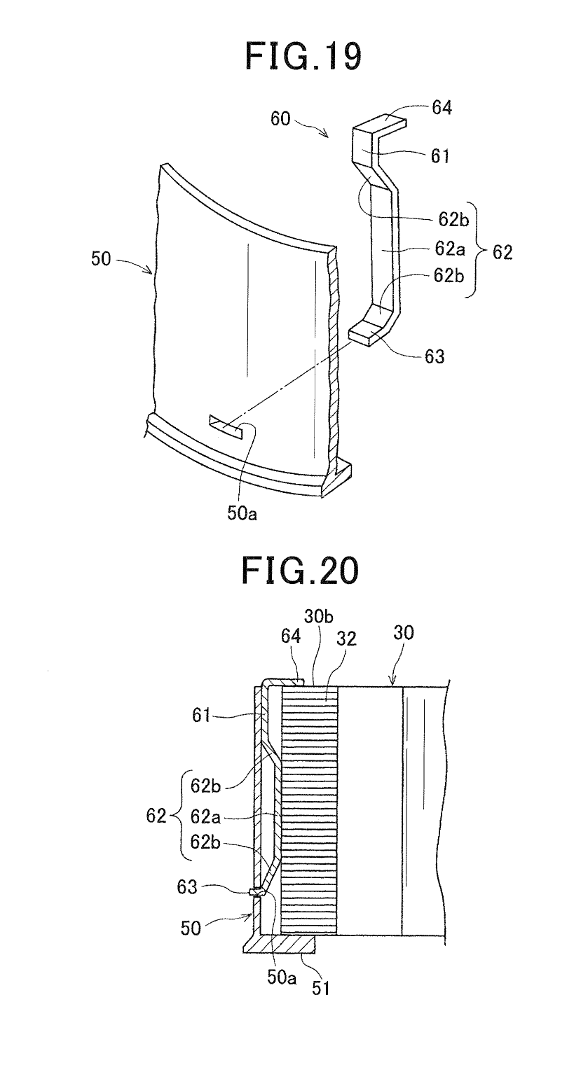

In comparison, in this modification, as shown in FIGS. 19-20, each of the first and second protruding portions of the outer cylinder 50 is made up of a protruding member 60 that is formed separately from and then joined to the main body of the outer cylinder 50.

More specifically, the protruding member 60 is configured to have a base portion 61, a protruding portion 62, a plug portion 63 and a restraining portion 64. The base portion 61 is arranged to seat on the radially inner surface of the main body of the outer cylinder 50 at the other axial end (i.e., the upper end in FIGS. 19-20) of the outer cylinder 50. The protruding portion 62 extends from the base portion 61 toward the one axial end (i.e., the lower end in FIGS. 19-20) of the outer cylinder 50. The protruding portion 62 is configured to include an abutting part 62a and a pair of oblique parts 62b. The abutting part 62a is centered in the protruding portion 62 and extends in the axial direction of the outer cylinder 50. The oblique parts 62b are respectively formed on opposite sides of the abutting part 62a and each extend obliquely with respect to the axial direction of the outer cylinder 50. The plug portion 63 extends from the protruding portion 62 radially outward. The restraining portion 64 extends from the base portion 61 radially inward to abut the other axial end face 30b (i.e., the upper end face in FIG. 20) of the stator core 30. In addition, before the protruding member 60 is mounted to the main body of the outer cylinder 50, the restraining portion 64 extends straight from the base portion 61.

On the other hand, the main body of the outer cylinder 50 has a plurality of mounting holes 50a formed therein so that each of the protruding members 60 making up the first and second protruding portions of the outer cylinder 50 can be mounted to the main body by fitting the plug portion 63 of the protruding member 60 into a corresponding one of the mounting holes 50a.

In addition, though there is shown only one mounting hole 50a in FIGS. 19-20, the number of the mounting holes 50a is equal to the number of the protruding members 60 (i.e., the number of the first and second protruding portions of the outer cylinder 50). The mounting holes 50a are spaced from one another in the circumferential direction of the outer cylinder 50 at predetermined intervals so as to respectively face the radially outer faces of the normal and specific core segments 32 and 32A of the stator core 30.

Before the outer cylinder 50 is fitted on the radially outer surface of the stator core 30, each of the protruding members 60 is first mounted to the main body of the outer cylinder 50 by fitting the plug portion 63 of the protruding member 60 into the corresponding mounting hole 50a from the radially inside of the main body. Then, the outer cylinder 50 is axially fitted from the other axial end (i.e., the upper end in FIGS. 19-20) onto the radially outer surface of the stator core 30, so that the protruding members 60 are respectively brought into abutment with the radially outer peripheries of the corresponding normal and specific core segments 32 and 32A. Thereafter, the restraining portions 64 of the protruding members 60 are bent radially inward to abut the other axial end face 30b of the stator core 30 (see FIG. 20). Consequently, radial displacement of the normal and specific core segments 32 and 32A of the stator core 30 is restrained by the protruding portions 62 of the protruding members 60. Moreover, axial displacement of the normal and specific core segments 32 and 32A is also restrained by the first restraining portion 51 of the outer cylinder 50 and the restraining portions 64 of the protruding members 60.

With the configuration of the outer cylinder 50 according to this modification, it is possible to achieve advantageous effects similar to those described in the first embodiment.

In addition, in the present modification, each of the protruding members 60 can be used to make up either one of the first protruding portions 55 or one of the second protruding portions 58 of the outer cylinder 50 according to the first embodiment by suitably adjusting the oblique angles of the oblique parts 62b of the protruding portion 62 of the protruding member 60 and the amount by which the abutting part 62a of the protruding portion 62 protrudes radially inward.

### [Eighth Modification]

In the first embodiment, the outer cylinder 50 has, for each of the normal core segments 32 of the stator core 30, one first protruding portion 55 formed therein to abut the normal core segment 32. Moreover, the outer cylinder 50 also has, for each of the specific core segments 32A of the stator core 30, one second protruding portion 58 formed therein to abut the specific core segment 32A. Accordingly, the number of the first and second protruding portions 55 and 58 formed in the outer cylinder 50 (i.e., 24 in the first embodiment) is equal to the number of the normal and specific core segments 32 and 32A of the stator core 30 (see FIGS. 2-3).

However, in terms of securing coaxiality between the outer to cylinder 50 and the stator core 30, it is only necessary that the first and second protruding portions 55 and 58 are formed in the outer cylinder 50 at three or more spots which are spaced from one another in the circumferential direction of the outer cylinder 50.

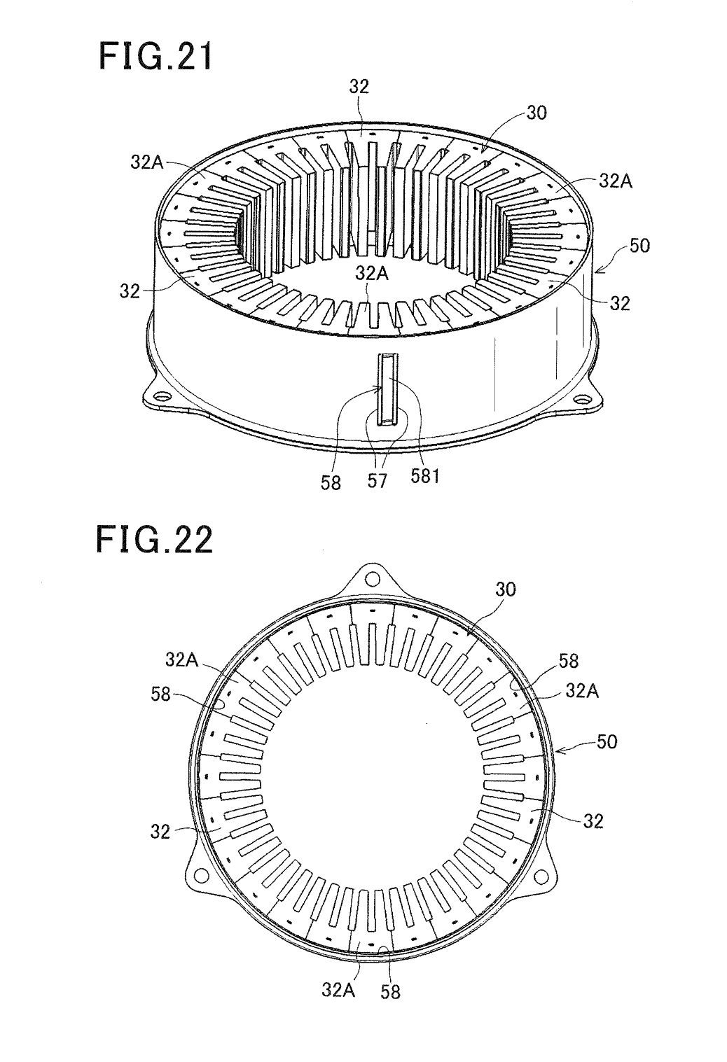

For example, in this modification, as shown in FIGS. 21-22, the stator core 30 includes a total of three specific stator segments 32A that are equally spaced in the circumferential direction of the stator core 30. On the other hand, in the outer cylinder 50, there are formed only three second protruding portions 58 (i.e., no first protruding portions 55) respectively at three spots in the circumferential direction of the outer cylinder 50. Each of the three second protruding portions 58 of the outer cylinder 50 is fitted in the recess 35 formed in the radially outer surface of a corresponding one of the three specific core segments 32A of the stator core 30 so that the second abutting part 581 of the second protruding portion 58 abuts the bottom surface of the recess 35.

With the above configuration, it is still possible to prevent relative rotation between the outer cylinder 50 and the stator core 30 while securing coaxiality between the outer cylinder 50 and the stator core 30.

### [Ninth Modification]

In the first embodiment, the outer cylinder 50 has, for each of the normal and specific core segments 32 and 32A of the stator core 30, one second restraining portion 53 formed therein to abut the core segment. Accordingly, the number of the second restraining portions 53 formed in the outer cylinder 50 is equal to the number of the normal and specific core segments 32 and 32A of the stator core 30 (see FIG. 2).

In comparison, in this modification, as shown in FIG. 23, the outer cylinder 50 has, for each of the normal and specific core segments 32 and 32A of the stator core 30, two second restraining portions 53 formed therein to abut the core segment. Accordingly, the number of the second restraining portions 53 formed in the outer cylinder 50 is twice the number of the normal and specific core segments 32 and 32A of the stator core 30.

Moreover, though not shown in the figures, the outer cylinder 50 may have, for each of the normal and specific core segments 32 and 32A of the stator core 30, three or more second restraining portions 53 formed therein to abut the core segment.

In addition, the outer cylinder 50 may also have, instead of the plurality of second restraining portions 53, a single annular second restraining portion 53 formed at the other axial end (i.e., the upper end in FIG. 23) thereof.

### [Tenth Modification]

In the first embodiment, of the first restraining portion 51 and the second restraining portions 53 formed respectively at opposite axial ends of the outer cylinder 50, only the second restraining portions 53 are formed by bending them radially inward after the outer cylinder 50 is fitted on the radially outer surface of the stator core 30 (see FIGS. 2-3).

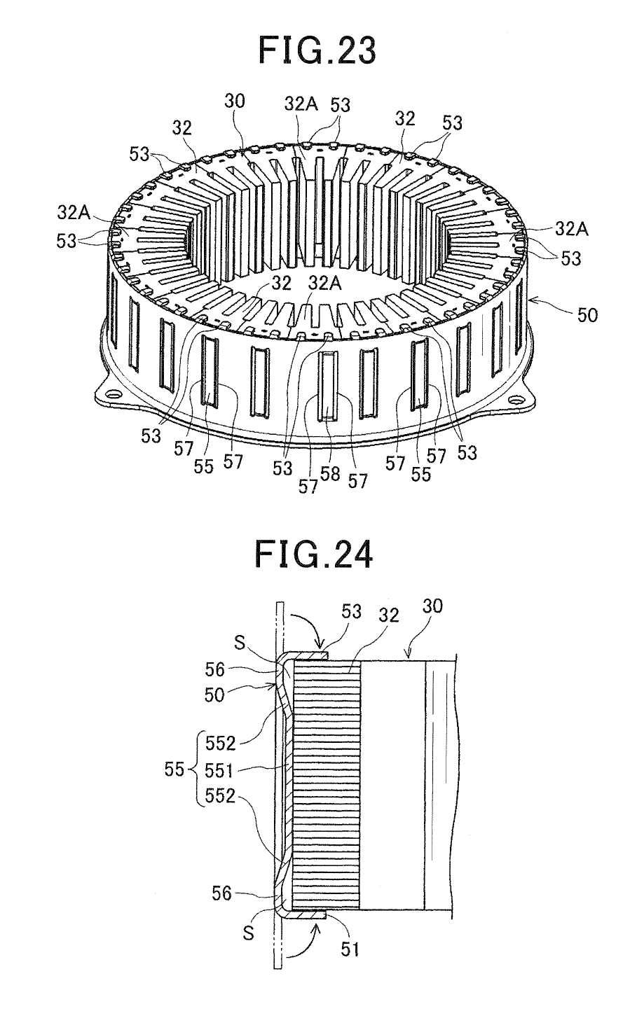

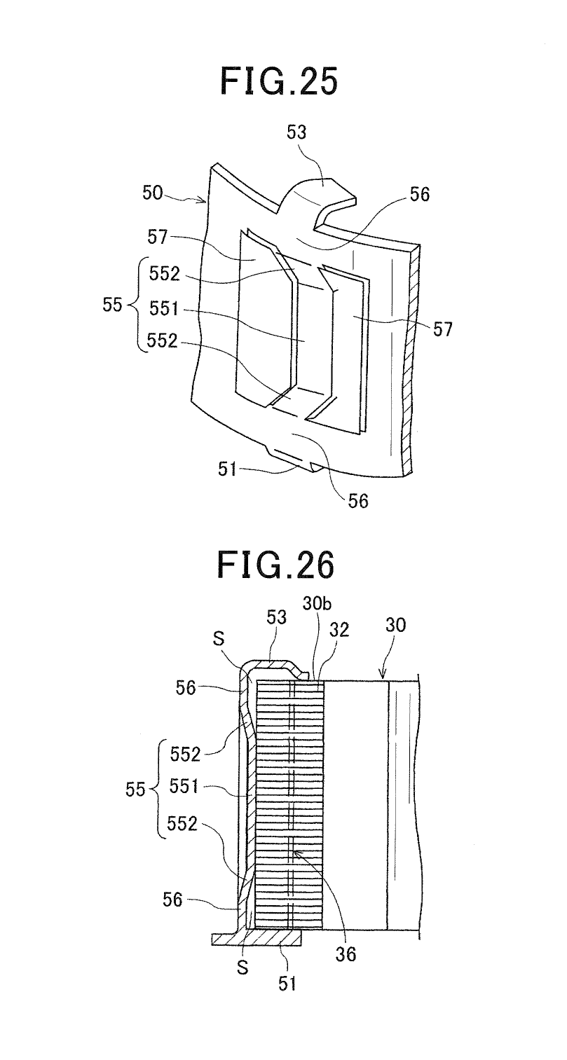

In comparison, in this modification, as shown in FIGS. 24-25, the outer cylinder 50 has a plurality of first restraining portions 51 instead of the single annular restraining portion 51 in the first embodiment. Further, as the second restraining portions 53, the plurality of first restraining portions 51 are also formed by bending them radially inward after the outer cylinder 50 is fitted on the radially outer surface of the stator core 30. In addition, though not shown in the figures, the plurality of first restraining portions 51 are equally spaced in the circumferential direction of the outer cylinder 50 so that each of the first restraining portions 51 can be brought into abutment with a circumferentially central part of a corresponding one of the normal and specific core segments 32 and 32A of the stator core 30.

### [Eleventh Modification]

In the first embodiment, the normal and specific core segments 32 and 32A, each of which is formed by fixing the axially-laminated magnetic steel sheets together by staking, are urged radially inward at the axially central parts thereof by the first and second abutting parts 551 and 581 of the corresponding first and second protruding portions 55 and 58 of the outer cylinder 50. Consequently, the laminated magnetic steel sheets might be axially spread (or separated from one another) at the radially inner ends of the normal and specific core segments 32 and 32A, thereby making contact with the coil ends 41 and 42 of the stator coil 40.

In consideration of the above problem, in this modification, as shown in FIG. 26, each of the second restraining portions 53 of the outer cylinder 50 is bent radially inward so that a distal end part of the second restraining portion 53 abuts the other axial end face 30b of the stator core 30 at a position on the radially inside of staking portions 36 of the stator core 30; at the staking portions 36, the laminated magnetic steel sheets of the normal and specific core segments 32 and 32A are fixed together by staking.

With the above configuration, it is possible to more reliably prevent the laminated magnetic steel sheets from axially spreading at the radially inner ends of the normal and specific core segments 32 and 32A, thereby securing a sufficient electrical clearance (or insulation distance) between the magnetic steel sheets and the coil ends 41 and 42 of the stator coil 40.

### [Twelfth Modification]

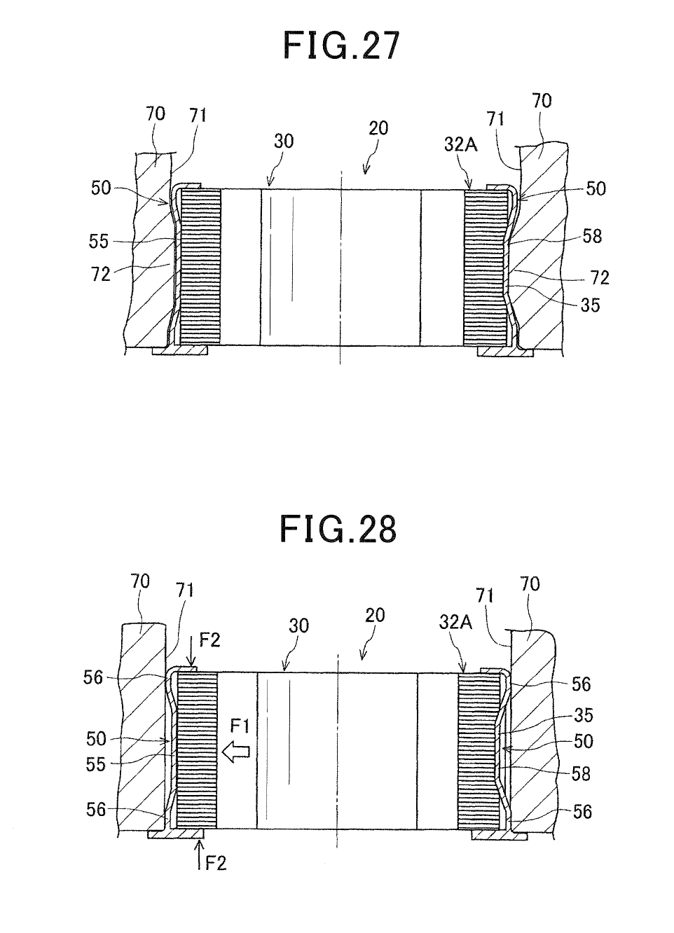

In the first embodiment, the stator 20 is received in the housing 10 (see FIG. 1). In comparison, in this modification, as shown in FIG. 27, the stator 20 is directly mounted to a stator-mounting portion 70 of the vehicle.

More specifically, in this modification, the stator 20 is mounted to a transaxle (i.e., the stator-mounting portion) 70 of the vehicle by fitting the outer cylinder 50 into a stator-mounting hole 71 formed in the transaxle 70. Further, the outer cylinder 50 is fitted in the stator-mounting hole 71 of the transaxle 70 so that the radially outer surfaces of the first and second protruding portions 55 and 58 of the outer cylinder 50 abut the inner wall surface of the stator-mounting hole 71 (i.e., the inner wall surface of the transaxle 70 which defines the stator-mounting hole 71). Furthermore, the inner wall surface of the stator-mounting hole 71 has a plurality of protruding portions 72 that protrude radially inward. Each of the protruding portions 72 is fitted in a corresponding one of recesses formed in the radially outer surfaces of the first and second protruding portions 55 and 58 of the outer cylinder 50, thereby axially positioning the stator 20 with respect to the transaxle 70.

### [Thirteenth Modification]

This modification is slightly different from the twelfth modification.

More specifically, in this modification, as shown in FIG. 28, the outer cylinder 50 is fitted in the stator-mounting hole 71 of the transaxle 70 so that the radially outer surfaces of the non-protruding portions 56 of the outer cylinder 50 abut the inner wall surface of the stator-mounting hole 71.

With the above configuration, the reaction forces F1 of the normal and specific core segments 32 and 32A of the stator core 30 against the first and second protruding portions 55 and 58 of the outer cylinder 50, which act radially outward, will cause forces F2 to increase: the forces F2 are applied by the first and second restraining portions 51 and 53 of the outer cylinder 50 axially inward to the normal and specific core segments 32 and 32A. Consequently, with the increased forces F2, it becomes possible for the first and second restraining portions 51 and 53 of the outer cylinder 50 to more reliably restrain axial displacement of the stator core 30.

What is claimed is:

1. A stator for a rotating electric machine, the stator comprising:
a hollow cylindrical stator core comprised of a plurality of core segments that are arranged in a circumferential direction of the stator core to adjoin one another in the circumferential direction;
a stator coil mounted on the stator core; and
an outer cylinder fitted on a radially outer periphery of the stator core,
wherein
the outer cylinder has, at least, a protruding portion and a non-protruding portion,
the protruding portion protrudes radially inward to include an abutting part that abuts the radially outer periphery of the stator core,
the non-protruding portion extends, without protruding radially inward, to define a radial clearance between the radially outer periphery of the stator core and a radially inner surface of the non-protruding portion, and
the protruding portion and the non-protruding portion are continuously formed in an axial direction of the outer cylinder.

2. The stator according to claim 1, wherein the protruding portion further includes an oblique part that extends obliquely with respect to the axial direction of the outer cylinder so as to connect the abutting part of the protruding portion with the non-protruding portion.

3. The stator according to claim 1, wherein the stator core has a recess formed in the radially outer periphery thereof, and
the protruding portion of the outer cylinder is fitted in the recess of the stator core so that the abutting part of the protruding portion abuts a bottom surface of the recess.

4. The stator according to claim 3, wherein the recess of the stator core also has a pair of circumferential wall surfaces that face each other in the circumferential direction of the stator core, and
the abutting part of the protruding portion of the outer cylinder also abuts both the circumferential wall surfaces of the recess.

5. The stator according to claim 1, wherein on opposite circumferential sides of the protruding portion of the outer cylinder, there are respectively formed a pair of slits each of which radially penetrates the outer cylinder so as to connect radially outer and inner surfaces of the outer cylinder.

6. The stator according to claim 5, wherein at each of a plurality of spots in the outer cylinder, there are formed one protruding portion as set forth in claim 1 and one pair of slits as set forth in claim 5, the plurality of spots being aligned with each other in the axial direction of the outer cylinder.

7. The stator according to claim 6, wherein each of the abutting parts of the protruding portions has an open end.

8. The stator according to claim 7, wherein all the open ends of the abutting parts are positioned closest to a same one of axial ends of the outer cylinder in the respective protruding portions.

9. The stator according to claim 1, wherein at each of three or more spots in the outer cylinder, there are formed one protruding portion and one non-protruding portion as set forth in claim 1, the three or more spots being spaced from one another in a circumferential direction of the outer cylinder.

10. The stator according to claim 9, wherein the number of spots where the protruding and non-protruding portions are formed is set to be equal to the number of the core segments of the stator core, and
for each of the core segments of the stator core, there is arranged a corresponding one of the protruding portions of the outer cylinder so that the abutting part of the corresponding protruding portion abuts a radially outer periphery of the core segment.

11. The stator according to claim 10, wherein the core segments of the stator core comprise specific core segments each having a recess formed in its radially outer surface and normal core segments each having no recess formed in its radially outer surface,
for each of the specific core segments, the corresponding protruding portion of the outer cylinder is fitted in the recess of the specific core segment so that the abutting part of the corresponding protruding portion abuts a bottom surface of the recess, and
for each of the normal core segments, the corresponding protruding portion of the outer cylinder is positioned so that the abutting part of the corresponding protruding portion abuts a circumferentially central area of the radially outer surface of the normal core segment.

12. The stator according to claim 1, wherein the outer cylinder further has, at each of opposite axial ends thereof, at least one restraining portion that abuts a corresponding one of opposite axial end faces of the stator core so as to restrain axial displacement of the stator core.

13. The stator according to claim 12, wherein at either or both of the axial ends of the outer cylinder, the at least one restraining portion is formed by bending an axial end portion of the outer cylinder radially inward.

14. The stator according to claim 1, wherein the outer cylinder is formed so that the protruding portion has a smaller thickness than the non-protruding portion.

15. The stator according to claim 1, wherein the stator is mounted to a stator-mounting portion of a vehicle so that a radially outer surface of the non-protruding portion of the outer cylinder abuts an inner wall surface of the stator-mounting portion.

16. The stator according to claim 1, wherein the stator is mounted to a stator-mounting portion of a vehicle so that a radially outer surface of the protruding portion of the outer cylinder abuts an inner wall surface of the stator-mounting portion.
